(19) United States
(12) Patent Application Publication
(10) Pub. No.: US 2005/0125322 A1
(43) Pub. Date: Jun. 9, 2005

(54) System, method and computer product to detect behavioral patterns related to the financial health of a business entity

(75) Inventors: Christina Ann Lacomb, Schenectady, NY (US); Janet Arlie Barnett, Pattersonville, NY (US); Allen Whitmore Case JR., Amsterdam, NY (US); Prakash Rao, Niskayuna, NY (US); Deniz Senturk, Schenectady, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/719,953

(22) Filed: Nov. 21, 2003

(51) Int. Cl. G06F 17/60

(52) U.S. Cl. 705/35; 705/1

(57) ABSTRACT

System, method and computer product to detect behavioral patterns related to the financial health of a business entity. In this invention, financial data and business data that relate to the business entity is extracted from various data sources. The financial data comprises quantitative financial data and/or qualitative financial data. The business data comprises quantitative business data and/or qualitative business data. The quantitative financial and business data is analyzed using a financial anomaly detection technique to detect the behavioral patterns associated with the business entity.

### BACKGROUND OF THE INVENTION

The invention relates generally to monitoring the financial health of a business entity and more specifically to a system and method for detecting behavioral patterns associated with the financial health of a business entity.

There are several commercially available tools that permit financial analysts to monitor the financial health of a business entity by analyzing many of the publicly available sources of financial information. These tools typically utilize quantitative financial information to generate risk scores indicative of the financial health of the business entity. Examples of quantitative financial data include financial statement reports, stock price and volume, credit and debt ratings and risk scores related to the business entity. Since quantitative financial information is typically generated periodically, these tools do not take into account, other forms of information such as business event data related to the business entity that may arise between financial statement reports. In addition, these tools generate risk scores with an assumption that the financial statement used to generate the score is accurate.

In order to account for the disadvantages associated with the above commercial tools, financial analysts typically monitor qualitative and quantitative business event information of a business entity through the use of forensic accounting techniques. Qualitative and quantitative business event information includes, for example, business event data that reflect certain behavioral symptoms or catalysts of financial stress associated with the business entity such as executive staff changes or accountant changes. The forensic accounting techniques determine financial inconsistencies related to a business entity through on-site audits of company books, interactive data mining of commercial databases, surveying of financial notes related to the business entity, interviews with executive teams, and assessment of accounting standards and control systems. A disadvantage with these techniques is the manual collection and assimilation of vast amounts of information. Also the fusion and collection of such vast amounts of information is not standardized, not subject to the rigor of statistical analysis, and is not a scalable technique.

Therefore, there is a need for a system and method for systematically extracting, analyzing, and fusing qualitative and quantitative financial data associated with the business entity to determine behavioral patterns associated with the financial health of the business entity.

### BRIEF DESCRIPTION OF THE INVENTION

Embodiments of the present invention address this and other needs. In one embodiment, there is a system for detecting behavioral patterns related to the financial health of a business entity. The system comprises a data collection application and an analytics engine. The data collection application is configured to extract financial data and business data that relates to the business entity from a data source. The financial data comprises at least one of quantitative financial data and qualitative financial data. The business data comprises at least one of quantitative business data and qualitative business data. The analytics engine is configured to perform analytics on the financial data and business data. The analytics engine analyses the quantitative financial data and quantitative business data using a financial anomaly detection technique to detect the behavioral patterns associated with the business entity.

In a second embodiment, there is a method and computer readable medium for detecting behavioral patterns related to the financial health of a business entity. In this embodiment, financial data and business data that relates to the business entity is extracted from a data source. The financial data comprises at least one of quantitative financial data and qualitative financial data. The business data comprises at least one of quantitative business data and qualitative business data. The quantitative financial data and qualitative business data is analyzed using a financial anomaly detection technique to detect the behavioral patterns associated with the business entity.

In a third embodiment, there is a method for detecting behavioral patterns related to the financial health of a business entity. In this embodiment, financial data and business data that relates to the business entity is extracted from a data source. The financial data comprises at least one of quantitative financial data and qualitative financial data. The business data comprises at least one of quantitative business data and qualitative business data. The quantitative financial data and quantitative business data is analyzed using a financial anomaly detection technique to detect the behavioral patterns associated with the business entity. Then the qualitative financial data and qualitative business data is analyzed using the financial anomaly detection technique to detect the behavioral patterns associated with the business entity. The financial anomaly detection technique detects the behavioral patterns based on an analysis of at least one of past financial measures related to the business entity, past financial measures related to at least one industrial segment associated with the business entity and current financial measures related to at least one industrial segment associated with the business entity. The method further comprises fusing the analyzed quantitative financial data and quantitative business data with the analyzed qualitative financial data and qualitative business data to detect the behavioral patterns associated with the business entity.

In a fourth embodiment, a method for detecting behavioral patterns related to the financial health of a business entity is provided. The method comprises extracting financial data and business data that relates to the business entity from a data source. The financial data comprises quantitative financial data and qualitative financial data. The business data comprises quantitative business data and qualitative business data. Then the qualitative financial data and qualitative business data is analyzed using a financial anomaly detection technique to detect the behavioral patterns associated with the business entity. The financial anomaly detection technique detects the behavioral patterns based on an analysis of at least one of past financial measures related to the business entity, past financial measures related to at least one industrial segment associated with the business entity and current financial measures related to at least one industrial segment associated with the business entity.

### BRIEF DESCRIPTION OF THE DRAWINGS

FIG. 1 shows a schematic of a general-purpose computer system in which a system for detecting behavioral patterns related to the financial health of a business entity may operate;

FIG. 2 is an illustration of a high-level component architecture diagram of a system for detecting behavioral patterns related to the financial health of a business entity that can operate on the computer system of FIG. 1; and

FIG. 3 is a flowchart depicting the steps performed by the system of FIG. 2.

### DETAILED DESCRIPTION OF THE INVENTION

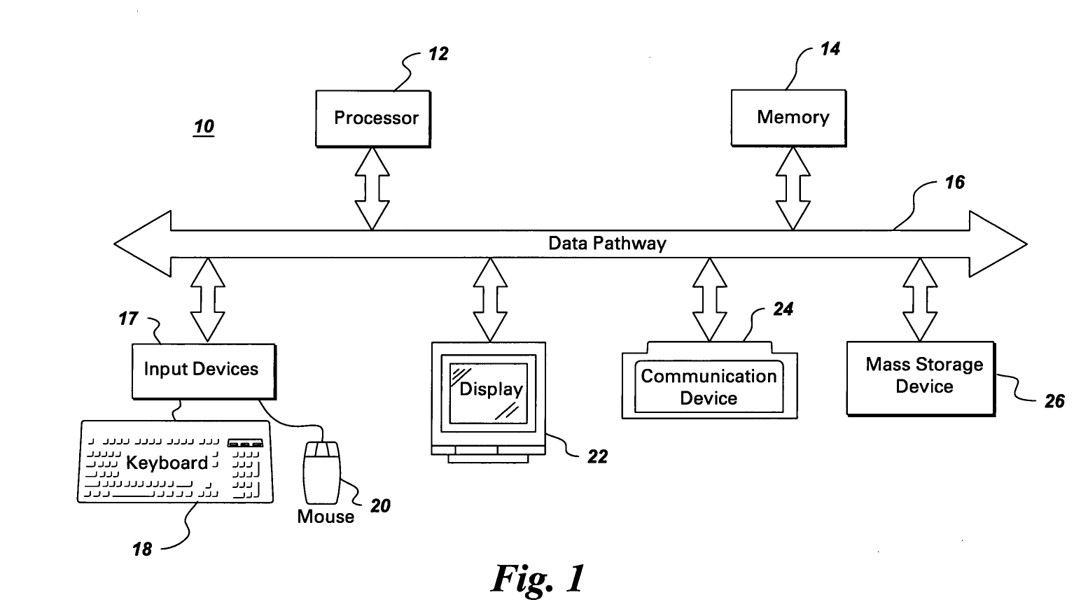

FIG. 1 shows a schematic of a general-purpose computer system 10 in which a system for detecting behavioral patterns related to the financial health of a business entity may operate. The computer system 10 generally comprises at least one processor 12, a memory 14, input/output devices 17, and data pathways (e.g., buses) 16 connecting the processor, memory and input/output devices.

The processor 12 accepts instructions and data from the memory 14 and performs various data processing functions of the system like extracting financial data related to a business entity from business and financial information sources and performing analytics on the extracted data. The processor 12 includes an arithmetic logic unit (ALU) that performs arithmetic and logical operations and a control unit that extracts instructions from memory 14 and decodes and executes them, calling on the ALU when necessary. The memory 14 stores a variety of data computed by the various data processing functions of the system 10. The data may include, for example, quantitative financial data such as financial measures and ratios or commercially available financial rating scores, qualitative business event information and behavioral patterns related to the financial health of the business entity. The memory 14 generally includes a random-access memory (RAM) and a read-only memory (ROM); however, there may be other types of memory such as programmable read-only memory (PROM), erasable programmable read-only memory (EPROM) and electrically erasable programmable read-only memory (EEPROM). Also, the memory 14 preferably contains an operating system, which executes on the processor 12. The operating system performs basic tasks that include recognizing input, sending output to output devices, keeping track of files and directories and controlling various peripheral devices. The information in the memory 14 might be conveyed to a human user through the input/output devices, and data pathways (e.g., buses) 16, in some other suitable manner.

The input/output devices may comprise a keyboard 18 and a mouse 20 that enters data and instructions into the computer system 10. Also, a display 22 may be used to allow a user to see what the computer has accomplished. Other output devices may include a printer, plotter, synthesizer and speakers. A communication device 24 such as a telephone, cable or wireless modem or a network card such as an Ethernet adapter, local area network (LAN) adapter, integrated services digital network (ISDN) adapter, or Digital Subscriber Line (DSL) adapter, that enables the computer system 10 to access other computers and resources on a network such as a LAN or a wide area network (WAN). A mass storage device 26 may be used to allow the computer system 10 to permanently retain large amounts of data. The mass storage device may include all types of disk drives such as floppy disks, hard disks and optical disks, as well as tape drives that can read and write data onto a tape that could include digital audio tapes (DAT), digital linear tapes (DLT), or other magnetically coded media. The above-described computer system 10 can take the form of a hand-held digital computer, personal digital assistant computer, notebook computer, personal computer, workstation, mini-computer, mainframe computer or supercomputer.

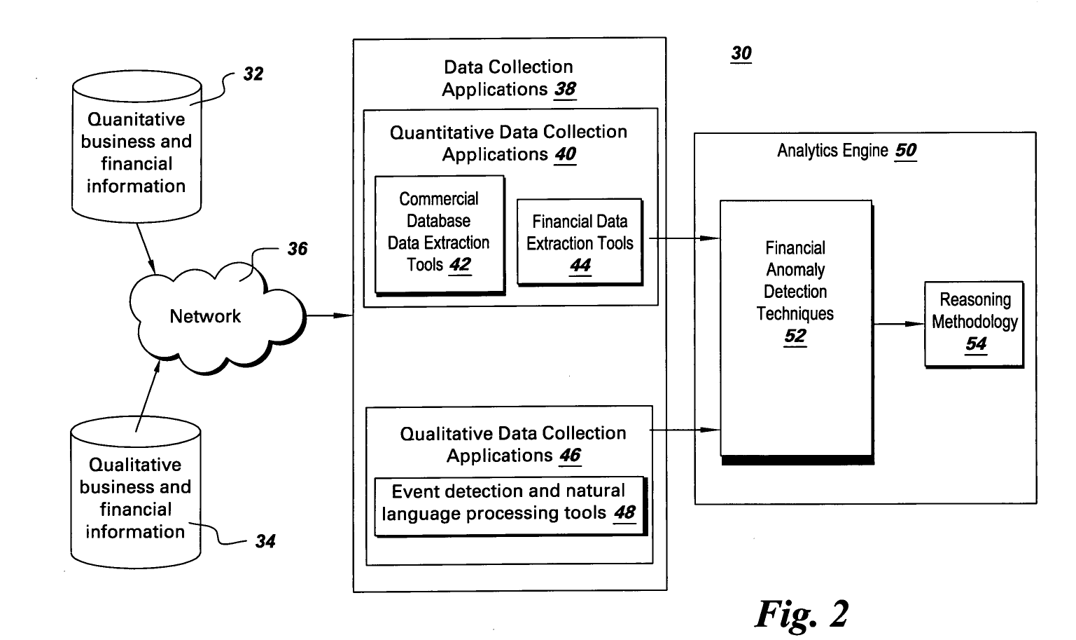

FIG. 2 is an illustration of a high-level component architecture diagram of a system 30 for detecting behavioral patterns related to the financial health of a business entity that can operate on the computer system 10 of FIG. 1. In the illustrated embodiment, the system 30 comprises data collection applications 38, and an analytics engine 50. One of ordinary skill in the art will recognize that the system 30 is not necessarily limited to these elements. It is possible that the system 30 may have additional elements or fewer elements than what is indicated in FIG. 2.

The data collection applications 38 are configured to extract financial data and business data that relate to the business entity from at least one data source. The financial data comprises quantitative financial data and/or qualitative financial data. The business data comprises quantitative business data and/or qualitative business data. As used herein, quantitative financial data refers to numerical data related to the financial state or history of the business entity. An illustrative, but non-exhaustive list of quantitative financial data includes financial statement data, accounts payable, accounts receivable, notes receivable, cash and cash equivalents, depreciation, deferred revenue, inventory, fixed assets, debt, total assets, total current assets, total current liabilities, total equity, total liabilities, cash flow from financing, cash flow from investing, cash flow from operations, operating expenses, other income, other expenses, operating income, income expense, cost of goods sold, extraordinary items, net income, total revenue, net intangibles, goodwill, non-recurring items, acquisitions, restructuring charges, in-process research and development, capital expenditures, reserves, bad debt, unbilled receivables, accounting changes, payment history, stock price and volume, credit and debt ratings industry performance averages and commercially available risk scores.

Qualitative financial data comprises qualitative financial event information related to the business entity. Qualitative financial event information are verbal or narrative pieces of data that are representative of certain business and financial actions or occurrences that are associated with or affect the business entity. An illustrative, but non-exhaustive list of qualitative financial data includes events related to defaults on credit or loan agreements, bankruptcy rumors, bankruptcy, debt restructure, loss of credit, investigations by the Security Exchange Commission (SEC), restatement of previously published earnings, change of auditors, management changes, layoffs, wage reductions, company restructures, refocused objectives, mergers and acquisitions, government changes and industry events that may impact a business entity.

Business data refers to quantitative or qualitative data associated with the business entity, that is not directly a reflection of financial standings associated with business entity, but related to the management, organization, process, or future or present standing of the business entity or any subdivision of the business entity. In a specific embodiment of the invention, quantitative business data includes, for example, employee count or lawsuits pending associated with the business entity and qualitative business data includes, for example, information on auditor change associated with the business entity or any non-financial event related to the business entity.

As depicted in FIG. 2, the data collection applications 38 extract the financial data and business data from the data sources through a network 36. The network 36 is a communication network such as an electronic or wireless network that connects the system 30 to the data sources. The network may comprise any of several suitable forms known to those in the art, including, for example, a private network such as an extranet or intranet or a global network such as a WAN (e.g., Internet). Further, it is not necessary that the data collection applications 38 extract the financial data and business data from a network. The financial data and business data may be manually extracted and provided on weekly CDs, for example.

As shown in FIG. 2, the data sources comprise quantitative business and financial information 32 and qualitative business and financial information 34 according to one embodiment of the present invention. Examples of quantitative business and financial information sources include financial results and internal financial statements related to business entities, stock exchange reports and quantitative risk scores produced by commercial databases such as Moody's KMV, Standard & Poor ratings and Dun and Bradstreet's PAYDEX®. Examples of qualitative business and financial information sources include, for example, on-line news sources such as YAHOO! News, FindArticles.com, etc., commercial news sources such as WALL STREET JOURNAL, BLOOMBERG, etc., business trade and industry publications, news reports, footnotes to financial statements, and qualitative financial data learned in interviews and discussions with a business entity.

The data collection applications 38 of the system 30 are further illustrated in FIG. 2 as comprising quantitative data collection applications 40 and qualitative data collection applications 46. The quantitative data collection applications 40 are configured to extract quantitative financial data and quantitative business data related to the business entity. In a specific embodiment of the invention, the quantitative data collection applications 40 comprise commercial database data extraction tools 42 and financial data extraction tools 44. The commercial database data extraction tools 42 are configured to extract payment information, analyst assessments and assess key commercial database values that reflect the financial standing of the business entity from one or more commercial databases such as Moody's KMV, Standard & Poor ratings, Dunn and Bradstreet's PAYDEX®, etc. The financial data extraction tools 44 are configured to extract financial data and financial measures from the quantitative financial data and quantitative business data. In a more specific embodiment of the invention, the financial data extraction tools comprise a financial document-understanding engine. The financial document-understanding engine utilizes a plurality of intelligence extraction algorithms, advanced heuristics, and document understanding techniques to automatically extract, read and interpret the quantitative financial data and quantitative business data. Commonly assigned U.S. Patent application Ser. No. 10/401,259 (GE Docket Number 126311) entitled “A method for the automated extraction of information from ASCII financial tables” and filed Mar. 28, 2003, provides a more detailed discussion of the financial document-understanding engine and its operation.

Referring again to FIG. 2, the qualitative data collection applications 46 comprise event detection and natural language processing tools 48 in accordance with one embodiment of the invention. The qualitative data collection applications 46 are configured to extract qualitative financial data and qualitative business data related to the business entity. The event detection and natural language processing tools 48 are configured to extract keywords and text patterns from the qualitative financial data and qualitative business data. In a specific embodiment of the invention, the event detection and natural language processing tools 48 comprise an event extraction engine that automatically extracts relevant events related to the business entity. Commonly assigned U.S. patent application Ser. No. 10/676928 (GE Docket Number 131013), entitled “Method, system and computer product for analyzing business risk using event information extracted from natural language sources”, which is incorporated herein by reference provides a more detailed discussion of the operation of the event extraction engine.

The financial data extracted by the quantitative and qualitative data collection applications is then input into an analytics engine 50 as depicted in FIG. 2. The analytics engine 50 analyzes the quantitative and/or qualitative financial data and business data extracted by the quantitative and qualitative data collection applications, using financial anomaly detection techniques as described below.

In one embodiment of the invention, the analytics engine 50 analyzes the quantitative financial data and quantitative business data using financial anomaly detection techniques 52 to detect the behavioral patterns associated with the business entity. As used herein, “behavioral patterns” refer to one or more events or outcomes that characterize the manner in which a business entity conducts itself or responds to its environment. Examples of behavioral patterns comprise misleading financials, financial statement fraud, financial decline, solid financial standings, likelihood of fraud, financial credit or investment risk and good credit or investment prospects. One of ordinary skill in the art will recognize that the above listing of behavioral patterns is for illustrative purposes and is not meant to limit the detection of other types of behavioral patterns by the system 30 such as, for example, leadership instability, heavy insider selling or earnings management.

In accordance with one embodiment of the present invention, the financial anomaly detection techniques 52 are used to identify financial anomalies from the quantitative financial data and quantitative business data (extracted by the financial data extraction tools 44) and detect the behavioral patterns associated with the business entity based on the identified financial anomalies. As used herein, the term “financial anomalies” refer to an indication of certain behavioral patterns associated with a business entity that are uncharacteristic of past behavioral patterns associated with the business entity or current or past behavioral patterns associated with at least one industrial segment associated with business entity. Illustrative examples of financial anomalies include unusually high debt, unusually high interest rates, deteriorating operating cash flow position, deteriorating earnings, deteriorating margins, sharp increase in accounts receivable relative to sales, sharp decline in sales volume, high inventories to sales ratio, rapid inventory growth, unusual sources and use of cash, such as unusually high cash from financing versus operations, bad debt reserves not correlated with revenues, unusual drop in unearned revenue, unusual increase in unbilled receivables/revenue, unusual increase in unearned revenue compared to sales, rapid increase in earnings, source of growth through acquisitions, unusually high capital spending, unusually high intangibles, performance otherwise atypical for company and performance otherwise atypical in industry.

In a specific embodiment of the present invention, the financial anomaly detection techniques 52 detect the behavioral patterns based on an analysis of past financial measures related to the business entity or current or past financial measures related to at least one industrial segment associated with the business entity. As used herein, the term “industrial segment” refers to segments of the business entity's industry of similar size. Industrial segments associated with a business entity could include for example, 8-10 companies within the same industry as the business entity, that are similar in size as measured by a common financial measure such as total sales for a given financial year. The above analysis is valuable for providing insight into the financial health associated with the business entity as well to understand the changes in the performance of the business entity against one or more industrial segments as a whole.

In a more specific embodiment of the present invention, the financial anomaly detection techniques of the invention detect the behavioral patterns from the quantitative financial and business data by statistically quantifying the extent to which a financial measure such as net income, total revenue, free cash flow, or working capital associated with a business entity is different from the past performance of the financial measure associated with the business entity or from the performance of the current or past financial measure associated with at least one industrial segment associated with the business entity. For example, the financial anomaly detection techniques of the invention are configured to statistically quantify terms such as “high” or “low” in financial measures. An example of such a term in a financial measure includes statistically quantifying the term “high” in “high net income”. The financial anomaly detection techniques of the invention comprise at least one of outlier detection, trend analysis, correlation analysis, regression and factor and cluster analysis. Outlier detection statistically measures whether a financial measure associated with the business entity is significantly ‘high’ or ‘low’. Trend analysis measures statistical significance in rates of change, by identifying significantly ‘high’ or ‘low’ increases or decreases. Correlation analysis and regression identify unusual correlations between quantitative metrics associated with the business entity. Factor and cluster (or rule based) analysis identifies differences in financial measure groupings associated with the business entity.

In general, any of the financial anomaly detection techniques described above can be used to detect behavioral patterns from the quantitative financial and business data. The subsequent paragraph is an illustration of the method used by the financial anomaly detection techniques, to detect the behavioral patterns associated with the business entity.

The financial anomaly detection techniques of the invention compare the financial measure associated with the business entity for a given time period to the average and standard deviation of the past financial measure associated with the business entity over the time period or over the average and standard deviation of the current or past financial measure associated with at least one industrial segment associated with the business entity over the same time period. The financial anomaly detection techniques then detect the presence of behavioral patterns based on the number of standard deviations by which the financial measure associated with the business entity deviates from the average value of the past financial measure associated with the business entity or the average value of the current or past financial measure associated with at least one industrial segment associated with the business entity.

In an alternate embodiment of the invention, the analytics engine analyzes the qualitative financial data and qualitative business data using the financial anomaly detection techniques 52 to detect the behavioral patterns associated with the business entity. In a specific embodiment, the financial anomaly detection techniques 52 detect the behavioral patterns from the qualitative financial and business data based on an analysis of at least one of past financial measures related to the business entity, past financial measures related to at least one industrial segment associated with the business entity and current financial measures related to at least one industrial segment associated with the business entity. In particular, the financial anomaly detection techniques analyze qualitative information related to the financial measure, such as, for example, qualitative financial event information, to detect the behavioral patterns. More specifically, the financial anomaly detection techniques 52 analyze event information from the event detection and natural language processing tools 48 and detect the behavioral patterns associated with the business entity based on proximity of the occurrence of the events, and/or a frequency of occurrence of the events. Further, the anomaly detection techniques could also use rule-based analysis to detect behavioral patterns from the qualitative financial and business data. An example of a rule to detect behavioral patterns associated with the business entity could be based on the number of acquisitions made by the business entity within the last five quarters.

In yet another alternate embodiment of the invention, the analytics engine 50 is further configured to fuse the analyzed quantitative financial data and quantitative business data with the analyzed qualitative financial data and the qualitative business data to detect behavioral patterns associated with the business entity. As used herein, the term “fuse” refers to the evaluation of the analyzed quantitative financial data and quantitative business data in combination and in relation to the analyzed qualitative financial data and qualitative business data or vice versa. In certain specific embodiments of the present invention, the analyzed qualitative financial data and qualitative business data is used to identify, substantiate, repudiate or explain the evidence of the detected behavioral patterns in the analyzed quantitative financial data and quantitative business data related to the financial health of the business entity.

In accordance with a particular embodiment of the invention, the analytics engine 50 is further configured to use a reasoning methodology 54 to fuse the analyzed quantitative financial data and quantitative business data with the analyzed qualitative financial data and qualitative business data to detect the behavioral patterns related to the business entity. In a specific embodiment of the present invention, the reasoning methodology is based on temporal relationships, interactions and confidence levels associated with the quantitative financial data and quantitative business data and qualitative financial and qualitative business data. The reasoning methodology is configured to fuse the qualitative financial data and qualitative business data with the quantitative financial data and quantitative business data by incorporation of temporal relationships and confidence levels associated with the financial data. As used herein, “temporal relationships” correspond to temporal occurrences of a plurality of events associated with the business entity. The reasoning methodology assigns a weight to the occurrence of the plurality of events. In one embodiment of the invention, the weight is based on the time of occurrences of the plurality of events and its effect on the financial health of the business entity. An example of a plurality of events, could include, for example, the release of a financial statement associated with the business entity and the resignation of the CEO associated with the business entity, within a time period. “Confidence levels” refer to a degree of certainty in the extracted quantitative financial data and quantitative business data and qualitative financial data and qualitative business data. For qualitative financial data and qualitative business data, the confidence level is based on one or more heuristics. In a specific embodiment, the heuristics take into consideration the reliability of the data source that was used to extract the qualitative financial data and qualitative business data and the confidence of the interpretation of the data source by the data collection applications. For quantitative financial data and quantitative business data, the confidence level is determined statistically. The subsequent paragraph illustrates an example use of the reasoning methodology to determine behavioral patterns related to the financial health of a business entity. The illustration describes an example interaction between the quantitative and qualitative financial data and business data associated with a business entity, wherein the analyzed qualitative financial data and business data is used to “substantiate” the detected behavioral patterns in the analyzed quantitative financial data and business data.

A result of a quantitative financial analysis of the financial debt associated with a business entity by the financial anomaly detection techniques may indicate a behavioral pattern that it is significantly higher than the financial debt exhibited by one or more industrial segments associated with the business entity. If analyzed qualitative financial data and business data related to the business entity also indicated that large off-balance-sheet financial debt existed at the same time, then the qualitative financial data and business data “substantiates” the concern that the business entity is carrying a financial risk of debt. In this case, the simultaneous temporal relationship between the qualitative and quantitative financial and business data is important to determine the behavioral patterns related to the financial health of the business entity, in this example, financial risk. If, however, the two types of debt existed at different time periods, the debt is of less significant concern. The reasoning methodology assigns a weight to the occurrence of the above events, wherein the weight is based on the time of occurrences of the events and its effect on the financial health of the business entity.

As is apparent from the above discussion, fusing the analyzed quantitative financial data and quantitative business data with the analyzed qualitative financial data and qualitative business data enables a more effective evaluation of the detected behavioral patterns in the analyzed quantitative financial data and quantitative business data. The analyzed quantitative financial data and quantitative business data, when evaluated in combination and in relation to the analyzed qualitative financial data and qualitative business data, substantiates the detected behavioral patterns seen in the analyzed quantitative financial data and quantitative business data.

The analytics engine 50 is further configured to generate an alert signal, wherein the alert signal comprises a visual representation and/or textual representation of the detected behavioral patterns associated with the business entity based on the identified financial anomalies. In a particular embodiment of the present invention, the alert signal is a degree of frequency, direction, severity or persistence of the detected behavioral patterns. In certain specific embodiments of the present invention, the frequency represents a rate of occurrence of the detected behavioral patterns, the direction represents a trend in the detected behavioral patterns with respect to a population, the severity represents the amount of deviation between the detected behavioral patterns with respect to a population, and the persistence represents a continued presence of the detected behavioral patterns over a period of time. In a more specific embodiment of the present invention, the alert signal is a visual representation of the extent and direction of the degree by which a financial measure associated with a business entity deviates from the average value of the past financial measure associated with the business entity or the average value of the current and past financial measure associated with at least one industrial segment associated with the business entity. Color codes are used to represent the extent and direction of deviation. Deviation in a positive or financially healthy manner, such as, for example, high cash from operations, is represented by a green color code whereas deviation in a negative or financially unhealthy manner, such as, for example, low cash from operations, is represented by a red color code. One of ordinary skill in the art will recognize that other color codes are possible and that other forms of generating an alert signal can be implemented in this invention.

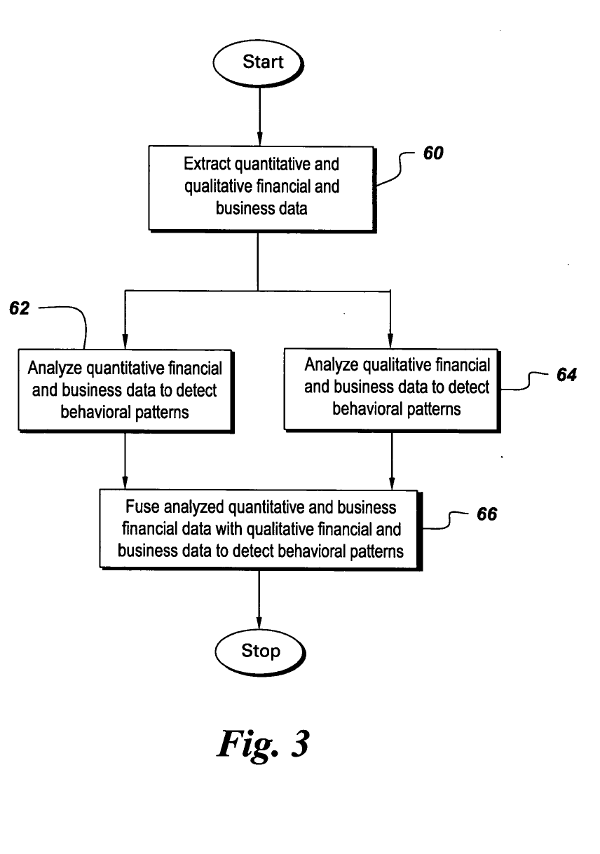

FIG. 3 is a flowchart depicting the steps performed by the system of FIG. 2 for detecting behavioral patterns related to the financial health of a business entity. In step 60, financial data and business data that relates to the business entity is extracted from a data source. The financial data comprises quantitative financial data and/or qualitative financial data and the business data comprises quantitative business data and/or qualitative business data. Extracting quantitative financial data and quantitative business data comprises extracting financial data and financial measures from the quantitative financial data and the quantitative business data. Extracting qualitative financial data and qualitative business data comprises extracting keywords and text patterns from the qualitative financial data.

Referring again to FIG. 3, the quantitative financial data and quantitative business data is analyzed in step 62, using a financial anomaly detection technique to detect the behavioral patterns associated with the business entity. As discussed above, the analysis comprises analyzing past financial measures related to the business entity or past or current financial measures related to at least one industrial segment associated with the business entity.

In an alternate embodiment, in step 64, the qualitative financial data and qualitative business data is analyzed using the financial anomaly detection technique to detect the behavioral patterns associated with the business entity. As discussed above, the analysis comprises analyzing past financial measures related to the business entity or past or current financial measures related to at least one industrial segment associated with the business entity.

In yet another alternate embodiment, in step 66, the analyzed quantitative financial data and quantitative business data from step 62 is further fused with the analyzed qualitative financial data and qualitative business data from step 64 to detect behavioral patterns associated with the business entity. As discussed above, the fusing is based on temporal relationships, interactions and confidence levels associated with the quantitative financial data and quantitative business data and qualitative financial data and qualitative business data.

The analysis further comprises displaying an alert signal, wherein the alert signal comprises a visual representation and/or textual representation of the detected behavioral patterns.

The previously described embodiments have many advantages, including the ability of the system of the invention to systematically extract, read and interpret quantitative and qualitative financial and business data, detect behavioral patterns related to the financial health of the business entity from the extracted quantitative financial and business data, detect behavioral patterns from the qualitative financial and business data and further utilize the analyzed qualitative financial and business data to substantiate the detected behavioral patterns in the analyzed quantitative financial and business data or vice versa.

The foregoing block diagrams and flowcharts of this invention show the functionality and operation of the system for detecting behavioral patterns related to the financial health of a business entity disclosed herein. In this regard, each block/component represents a module, segment, or portion of code, which comprises one or more executable instructions for implementing the specified logical function(s). It should also be noted that in some alternative implementations, the functions noted in the blocks may occur out of the order noted in the figures or, for example, may in fact be executed substantially concurrently or in the reverse order, depending upon the functionality involved. Also, one of ordinary skill in the art will recognize that additional blocks may be added. Furthermore, the functions can be implemented in programming languages such as Java and Matlab however, other languages can be used, such as Perl, Visual Basic, C++, Mathematica and SAS.

The various embodiments described above comprise an ordered listing of executable instructions for implementing logical functions. The ordered listing can be embodied in any computer-readable medium for use by or in connection with a computer-based system that can retrieve the instructions and execute them. In the context of this application, the computer-readable medium can be any means that can contain, store, communicate, propagate, transmit or transport the instructions. The computer readable medium can be an electronic, magnetic, optical, electromagnetic, or infrared system, apparatus, or device. An illustrative, but non-exhaustive list of computer-readable mediums can include an electrical connection having one or more wires (electronic), a portable computer diskette (magnetic), RAM (magnetic), ROM (magnetic), EPROM or Flash memory (magnetic), an optical fiber (optical), and a portable compact disc read-only memory (CDROM) (optical).

Note that the computer readable medium may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

It is apparent that there has been provided with this invention, a method, system and computer product for detecting behavioral patterns related to the financial health of a business entity. While the invention has been particularly shown and described in conjunction with a preferred embodiment thereof, it will be appreciated that variations and modifications can be effected by a person of ordinary skill in the art without departing from the scope of the invention.

1. A system for detecting behavioral patterns related to the financial health of a business entity, comprising:
at least one data collection application configured to extract financial data and business data that relates to the business entity from at least one data source, wherein the financial data comprises at least one of quantitative financial data and qualitative financial data, and wherein the business data comprises at least one of quantitative business data and qualitative business data; and
an analytics engine configured to perform analytics on the financial data and business data, wherein the analytics engine is configured to:
analyze the quantitative financial data and quantitative business data using a financial anomaly detection technique to detect the behavioral patterns associated with the business entity.

2. The system of claim 1, wherein the analytics engine is further configured to analyze the qualitative financial data and qualitative business data using the financial anomaly detection technique to detect the behavioral patterns associated with the business entity.

3. The system of claim 2, wherein the analytics engine is further configured to fuse the analyzed quantitative financial data and quantitative business data with the analyzed qualitative financial data and qualitative business data to detect the behavioral patterns associated with the business entity.

4. The system of claim 1, wherein the data source comprises at least one of quantitative business and financial information sources and qualitative business and financial information sources.

5. The system of claim 1, wherein the behavioral patterns comprises at least one of likelihood of fraud, financial credit or investment risk and good credit or investment prospect associated with the business entity.

6. The system of claim 1, wherein the data collection application comprises at least one of quantitative data collection applications and qualitative data collection applications.

7. The system of claim 6, wherein the quantitative data collection applications comprise commercial database data extraction tools and financial data extraction tools.

8. The system of claim 7, wherein the financial data extraction tools are configured to extract financial data and financial measures from the quantitative financial data and quantitative business data.

9. The system of claim 6, wherein the qualitative data collection applications comprise event detection and natural language processing tools.

10. The system of claim 9, wherein the event detection and natural language processing tools are configured to extract keywords and text patterns from the qualitative financial data and qualitative business data.

11. The system of claim 1, wherein the financial anomaly detection technique comprises at least one of outlier detection, trend analysis, correlation analysis, regression and factor and cluster analysis.

12. The system of claim 1, wherein the financial anomaly detection technique detects the behavioral patterns based on an analysis of at least one of past financial measures related to the business entity, past financial measures related to at least one industrial segment associated with the business entity and current financial measures related to at least one industrial segment associated with the business entity.

13. The system of claim 3, wherein the analytics engine is further configured to use a reasoning methodology to detect the behavioral patterns related to the business entity, and wherein the reasoning methodology is based on temporal relationships, interactions and confidence levels associated with the business data and financial data.

14. The system of claim 1, wherein the analytics engine is further configured to generate an alert signal, wherein the alert signal comprises at least one of a visual representation and textual representation of the detected behavioral patterns.

15. A method for detecting behavioral patterns related to the financial health of a business entity, comprising:
extracting financial data and business data that relates to the business entity from at least one data source, wherein the financial data comprises at least one of quantitative financial data and qualitative financial data, and wherein the business data comprises at least one of quantitative business data and qualitative business data; and
analyzing the quantitative financial data and quantitative business data using a financial anomaly detection technique to detect the behavioral patterns associated with the business entity.

16. The method of claim 15 further comprises analyzing the qualitative financial data and qualitative business data using the financial anomaly detection technique to detect the behavioral patterns associated with the business entity.

17. The method of claim 16 further comprises fusing the analyzed quantitative financial data and quantitative business data with the analyzed qualitative financial data and qualitative business data to detect the behavioral patterns associated with the business entity.

18. The method of claim 15, wherein the data source comprises at least one of quantitative business and financial information sources and qualitative business and financial information sources.

19. The method of claim 15, wherein the behavioral patterns comprise at least one of likelihood of fraud, financial credit or investment risk and good credit or investment prospect associated with the business entity.

20. The method of claim 15, wherein the extracting further comprises extracting quantitative financial data and quantitative business data and extracting qualitative financial data and qualitative business data that relates to the business entity.

21. The method of claim 20, wherein extracting quantitative financial data and quantitative business data further comprises extracting financial data and financial measures from the quantitative financial data and quantitative business data.

22. The method of claim 20, wherein extracting qualitative financial data and qualitative business data further comprises extracting keywords and text patterns from the qualitative financial data and qualitative business data.

23. The method of claim 15, wherein the financial anomaly detection technique detects the behavioral patterns based on an analysis of at least one of past financial measures related to the business entity, past financial measures related to at least one industrial segment associated with the business entity and current financial measures related to at least one industrial segment associated with the business entity.

24. The method of claim 17, wherein fusing the analyzed quantitative financial data and quantitative business data with the analyzed qualitative financial data and qualitative business data is based on temporal relationships, interactions and confidence levels associated with the quantitative financial data and quantitative business data and qualitative financial data and qualitative business data.

25. The method of claim 15, further comprises generating an alert signal, wherein the alert signal comprises at least one of a visual representation and textual representation of the detected behavioral patterns.

26. A computer-readable medium storing computer instructions for instructing a computer system to detect behavioral patterns related to the financial health associated with a business entity, the computer instructions comprising:
extracting financial data and business data that relates to the business entity from at least one data source, wherein the financial data comprises at least one of quantitative financial data and qualitative financial data, and wherein the business data comprises at least one of quantitative business data and qualitative business data; and
analyzing the quantitative financial data and quantitative business data using a financial anomaly detection technique to detect the behavioral patterns associated with the business entity.

27. The computer-readable medium of claim 26 further comprises analyzing the qualitative financial data and qualitative business data using the financial anomaly detection technique to detect the behavioral patterns associated with the business entity.

28. The computer-readable medium of claim 27 further comprises instructions for fusing the analyzed quantitative financial data and quantitative business data with the analyzed qualitative financial data and qualitative business data to detect the behavioral patterns associated with the business entity.

29. The computer-readable medium of claim 26, wherein the extracting comprises instructions for extracting quantitative financial data and quantitative business data and extracting qualitative financial data and qualitative business data that relates to the business entity.

30. The computer-readable medium of claim 26, wherein the financial anomaly detection technique detects the behavioral patterns based on an analysis of at least one of past financial measures related to the business entity, past financial measures related to at least one industrial segment associated with the business entity and current financial measures related to at least one industrial segment associated with the business entity.

31. The computer-readable medium of claim 28, further comprises instructions for fusing the analyzed quantitative financial data and quantitative business data with the analyzed qualitative financial data and qualitative business data based on temporal relationships, interactions and confidence levels associated with the quantitative financial data and quantitative business data and qualitative financial data and qualitative business data.

32. The computer readable medium of claim 26 further comprises instructions for generating an alert signal, wherein the alert signal comprises at least one of a visual representation and textual representation of the detected behavioral patterns.

33. A method for detecting behavioral patterns related to the financial health of a business entity, comprising:
extracting financial data and business data that relates to the business entity from at least one data source, wherein the financial data comprises at least one of quantitative financial data and qualitative financial data, and wherein the business data comprises at least one of quantitative business data and qualitative business data;
analyzing the quantitative financial data and quantitative business data using a financial anomaly detection technique to detect the behavioral patterns associated with the business entity;
analyzing the qualitative financial data and qualitative business data using the financial anomaly detection technique to detect the behavioral patterns associated with the business entity;
wherein the financial anomaly detection technique detects the behavioral patterns based on an analysis of at least one of past financial measures related to the business entity, past financial measures related to at least one industrial segment associated with the business entity and current financial measures related to at least one industrial segment associated with the business entity; and
fusing the analyzed quantitative financial data and quantitative business data with the analyzed qualitative financial data and qualitative business data to detect the behavioral patterns associated with the business entity.

34. A method for detecting behavioral patterns related to the financial health of a business entity, comprising:
extracting financial data and business data that relates to the business entity from at least one data source, wherein the financial data comprises at least one of quantitative financial data and qualitative financial data, and wherein the business data comprises at least one of quantitative business data and qualitative business data; and
analyzing the qualitative financial data and qualitative business data using a financial anomaly detection technique to detect the behavioral patterns associated with the business entity, wherein the financial anomaly detection technique detects the behavioral patterns based on an analysis of at least one of past financial measures related to the business entity, past financial measures related to at least one industrial segment associated with the business entity and current financial measures related to at least one industrial segment associated with the business entity.
